(19) United States
(12) Patent Application Publication
(10) Pub. No.: US 2008/0122938 A1
(43) Pub. Date: May 29, 2008

(54) System for Surveillance and a Method for the Application Thereof

(75) Inventors: Patrick Broberg, Halmstad (SE); Magnus Svensson, Halmstad (SE); Torbjorn Gilda, Goteborg (SE)

Correspondence Address: MERCHANT & GOULD PC, P.O. BOX 2903, MINNEAPOLIS, MN, 55402-0903, US

(73) Assignee: EMWITECH HOLDING AB, Halmstad (SE)

(21) Appl. No.: 11/630,094

(22) PCT Filed: Jun. 20, 2005
(86) PCT No.: PCT/SE05/00980

§ 371 Date: Oct. 3, 2007

(30) Foreign Application Priority Data
Jun. 18, 2004 (SE) 0401574-9

(51) Int. Cl. H04N 5/38; H04B 1/66; G06K 9/36

(52) U.S. Cl. 348/222.1; 375/240.01; 382/232; 348/E05.093

(57) ABSTRACT

A method and a system (100) for transmission of a large amount of data over a first dedicated wireless link (A) at a first frequency, such as 2.4 GHz. If the signal strength is weak, the data is further compressed. If the signal strength is further weaker, a second wireless link (B) is used at a second frequency, such as 868 MHZ. The second wireless link (B) is at the same time used as a network system for exchange of information in which the nodes of the system operates as nodes in a multi-hop system.

### TECHNICAL FIELD

The present invention relates to a system for surveillance, which is based on a wireless sensor network.

The invention also relates to a method for the application of the system, wherein dual radio technology is provided for transmission of messages, sound and images/videos.

### BACKGROUND OF THE INVENTION

Most of the currently used wireless alarm or security systems comprise a central unit, one or several sensors, for example PIR-sensors, motion sensors, smoke detectors, sound detectors, and/or camera sensors. The radio technologies of those systems use often frequencies of 433 MHz or 868 MHz and are operated in one-way or two-way directions, but are limited in range and are easy to interfere with. The systems can transfer alarms to a destination by means of Internet, GSM/GPRS, and the telephone network or to a monitor operating according to PAL/NTSC. However, most of these systems are only partly wireless and need wiring for installation of the central unit and for power supply.

The currently existing alarm systems that comprise a camera integrated into the system have problems with the power supply to the cameras. Most of these systems need a continuous power supply of the cameras for a stable operation, which results in wiring and does not give the possibility to arrange the cameras everywhere resulting in a less dynamic system. When the cameras are battery powered they cannot be in operation all the time, since this requires a large amount of current and the batteries will then be emptied too fast, which does not give a continuous, reliable performance.

Another drawback of previously known alarm systems is that they are easy to bring out of use by sabotage, since the central unit of a system, which controls the entire operation, may be easily accessible.

WO 00/21053 describes a security alarm system, or more particularly, a wireless home fire and alarm system. WO03/043316 describes a camera for surveillance having two camera sensors, one colour sensor and one monochromatic sensor; IR-lightning; PIR-elements; battery supply; and power saving functions.

### SUMMARY OF THE INVENTION

An object of the present invention is to eliminate the drawbacks mentioned above, which is achieved by assigning to the method the characteristics according to claim 1. In a first aspect there is provided a method for transmission of a large amount of information, such as images, videos and sound, over a radio frequency link. The transmission is performed on a first frequency at normal signal quality of the transmission, and at full rate of the information; and on the first frequency, but with the information being further compressed when the signal quality of the transmission is below the normal signal quality; and on a second frequency when the transmission on the first frequency is substantially impossible. The compression of the information is performed in several steps, depending on the signal quality and/or the number of hops during transmission. The transmission at the second frequency takes place over several nodes in a multi-hop network in a predetermined path, and takes place in both directions. The information comprises image information, which is compressed according to JPEG-standard including a header, wherein the header is removed before transmission. The image information is obtained by a camera unit. According to another aspect, there is provided a system for surveillance comprising a radio module transmitting at a first frequency and having a first bandwidth, and comprising an additional radio module transmitting at a second frequency having a second bandwidth, which is smaller than the first bandwidth. The additional radio module is a multi-hop radio module. The system comprises at least one camera having at least one camera chip. The system uses two different digital radiofrequencies, e.g. 2.4 GHz for transmitting images/videos or sound within the system and e.g. 868 MHz for sending commands from one sensor to another, however, if the 2.4 GHz signal is to weak, the 868 MHz frequency is also used for transmitting images or sound.

### BRIEF DESCRIPTION OF THE DRAWINGS

Further objects, features and advantages of the invention will appear from the following detailed description of embodiments of the invention with reference to the accompanying drawings, in which;

FIG. 1 is a schematic view of a system for surveillance,

FIG. 2 is a diagram showing the components of a camera included in the system,

FIG. 3 is a schematic diagram showing components of the processor, which is included in the camera,

FIG. 4 is a schematic diagram showing a power management unit according to the invention,

FIG. 5 is a schematic view showing transmissions of signals from the camera using a first or a second frequency according to the method of the invention, and

FIG. 6 is a schematic view showing a reserved route within a multi-hop network for transmitting images from the camera.

### DESCRIPTION OF EMBODIMENTS OF THE INVENTION

The same reference numerals have been used to indicate the same parts throughout the figures to increase the readability of the specification and for the sake of clarity.

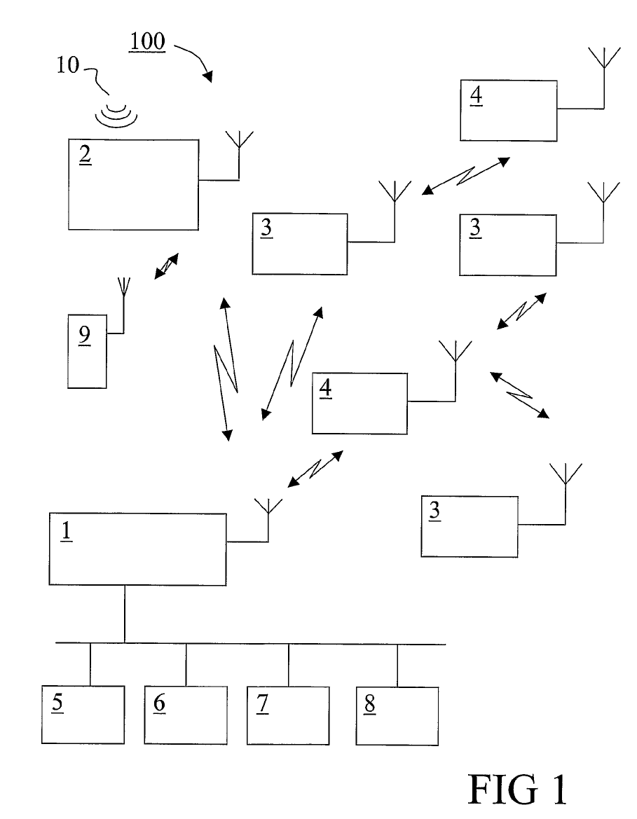

FIG. 1 shows an integrated system for surveillance 100 comprising a connection unit 1, a control panel 2, sensors 3, and one or more cameras 4 having sensors.

The connection unit 1 is a master of a multi-hop network and includes an multi-hop radio module, for example transmitting at the frequency band of 868 MHz, and a radio module 27 having a broad bandwidth, for example transmitting at the frequency band of 2.4 GHz. The sensors 3 and the cameras 4 are nodes of a multi-hop network as described below.

The multi-hop network may be a system as described in the concurrently filed international patent application entitled: “Method and a system for providing communication between several nodes and a master”, the content of which is included in the present specification by reference.

To summarize, the network comprises a master and several nodes. The nodes are arranged in groups, so that the first group comprises all nodes inside the coverage area of the master. The second group is outside the coverage area of the master but inside the coverage area of any node of the first group, etc. Any node reaches the master via a node in a previous group in a multi-hop approach, and vice versa. The time slots are assigned in dependence of the distance to the master. In a message period, in which the master sends a message to any node, the first group is assigned a first group of time slots, and the second group is assigned a second group of time slots, following the first group of time slots, etc. In this way, the message from the master can be sent out to all nodes in a single message period. When a node wants to send information to the master, the time slots are arranged in the opposite order, in an information period, which means that the information can reach the master in a single information period. Normally, a message period is followed by an information period, which in turn is followed by a sleep period to save battery power. The message sent by the master may comprise synchronization information, so that the nodes may adjust the time slots appropriately. The message may also comprise information of assignment of time slots and information of adjacent nodes time slots, which information is saved by each node. The node needs only to listen during the time slots of adjacent nodes, and may power down the receiver during other time periods, thus saving battery power.

In order to send information according to a selected route, only the nodes involved in the route is given time slots in a sequence, while the other nodes are sleeping. In this way, the nodes may send large information via the nodes in the route to the master and/or vice versa in a multi-hop fashion.

In some cases, it is required to wake up all the nodes during a sleep period, for example in an emergency case. This may take place by the master emitting a Dirac pulse. A Dirac pulse is a pulse having infinite short time duration and a unity of energy. Such a pulse consists of all frequencies and can be heard by any receiver. In this case, all nodes need to have a receiver active during the sleep period, or at least during part of the sleep period. At least the master may be provided with a Dirac pulse generator, since the master normally is connected to the mains supply. Some of the nodes can also emit Dirac pulses, which however consumes battery power.

The connection unit 1 receives the images from the cameras 4 for storing or for transmission. At an alarm, the connection unit 1 conveys the alarm from the system to e.g. an external control centre by Internet 5, GSM/GPRS 6, telephone network 7 or PAL/NTSC 8.

The control unit 2 is used for adjustments of the system 100 and for controlling the alarm thereof. The control unit 2 comprises a multi-hop radio module, a WLAN (Wireless Local Area Network) and a Bluetooth module; the latter enables to connect a mobile telephone 9 for controlling the system 100 from a remote location by the mobile telephone. The control unit 2 includes also RFID-technology, which enables to distinctly and immediately control certain functions, e.g. the on/off function of the alarm, and which also enables to use the system as an access system.

The sensors 3 can be of different types, such as PIR (passive infrared)—sensors, motion sensors, smoke detectors, temperature sensors, etc.

The connection unit 1, the control unit 2, the sensors 3, and the cameras 4 are battery powered but can alternatively be power supplied by wires.

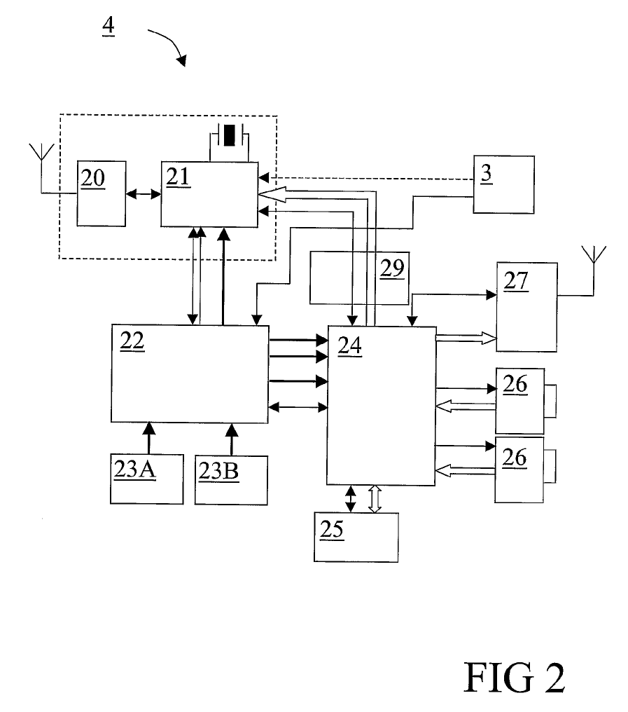

FIG. 2 shows one of the cameras 4, in connection with an external sensor 3, comprising a transceiver or a multi-hop radio module 20; a low-power processor or CPU 21 having a clock crystal, whereby the CPU 21 controls the camera 4; a power management system 22 for intelligent power supply of the components of the camera 4; batteries 23A and 23B for power supply; a video/image and radio processor 24 including integrated image compression and processing, camera interface, memory interface and radio protocol; a memory 25 for intermediate storing of images before image/video compression; a colour and/or a monochrome (black-and-white) camera chip 26 including the camera sensor, a broadband radio module 27, having a radio transceiver and a base band processor; optionally an external sensor 3 that enables the camera 4 to control occasional events; and a configuration interface 29.

The camera 4 can be started either by a command via the multi-hop radio module 20, or by activation by the sensor 3, or intermittently by the CPU 21, or by a signal from the radio module 27, when the camera 4 is powered by an external supply, which will be explained below. The camera 4 is wirelessly operated and has integrated functions for power supply control.

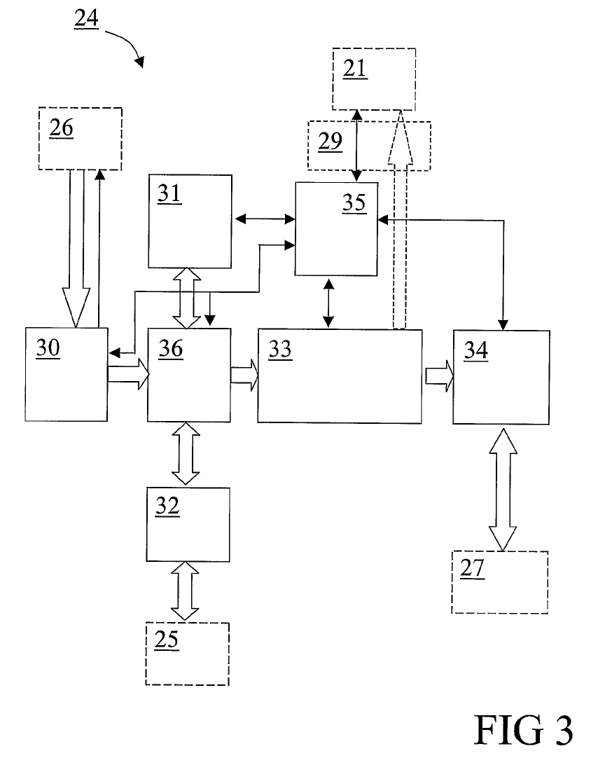

The video/image and radio processor 24 is an IC (Integrated Circuit), for example a CPU (Central Processing Unit), an ASIC (Application Specific Integrated Circuit), or a FPGA (Field Programmable Gate Array), that performs image exposure, image analysis and image compression for wireless transmission of images and video sequences within the system 100. FIG. 3 shows the processor 24 comprising one or two camera interfaces 30 for digital input, the one or two camera sensors being connected thereto; an image analysis unit 31 for performing motion detection, object identification, etc.; a memory controller 32 having a memory interface towards a memory 25, in which non-compressed images are stored for later compression/image analysis; a compression pipeline 33 for compressing and feeding compressed image data; a controller 34 for communication with a radio base band unit 27; a main control unit 35 for controlling the image exposure, the image analysis and the image compression; and a sub control unit 36 for controlling whereto the data should be sent within the processor 24.

At start up, the camera interface 30 performs the configuration of the camera sensor chip 26 that are connected to the processor 24, and collects data from the camera chip 26 at image exposure. The camera interface 30 comprises a unit for this configuration and a pipelined logical unit, which receives data from the camera chip 26 and which can convert these data from the format given by the camera chip 26 to the format required for the image processing and compression, e.g. from rawRGB-format to YCbCr- or YUV-format (pixel format). If the camera chip 26 is chosen to give the required data format without conversion, this function is closed, which can be set by the main control unit 35 controlled by the external CPU 21. The camera interface 30 transmits thereafter its data to the sub control unit 36.

At operation, the memory controller 32 performs the initiation and operation communication of the memory 25, e.g. a SDRAM (Synchronous Dynamic Random Access Memory) or a flash memory, after receiving data- and writing/reading-commands from the sub controller unit 36. It is possible to operate the memory 25 and the memory controller 32 on a higher clock frequency than the clock frequency used for the rest of the processor 24, which will decrease the external data bus width in comparison with the internal one of the processor 24.

The image analysis unit 31 analyses and modifies images before compression, for example, motion detection, or registration of changes of images compared to a previous image. The image analysis unit 31 receives data from the sub control unit 36 and returns processed data to it. The main control unit 35 determines and controls the analysis that should be performed. The image analysis unit 31 can conduct DCT (Discrete Cosine Transform) calculation of an image block, or motion detection within an image for calculation of a motion vector within an image block, which is used to follow the motion of an object. The analysis unit 31 can also perform differential calculation within a image block, which enables compression of only those parts of an image that have been sufficiently changed in comparison with a reference image; a method enabling to save bandwidth at wireless transmission.

The processor 24 senses if one or two of the camera sensors are connected and adapts the compression to this fact. The compression pipeline 33 comprises all necessary steps, well known for the skilled person, for compressing an image to a JPEG (Joint Image Experts Group) format. The JPEG format comprises a header. However, part of the header is removed before transmission and then added again after the transmission, thus, reducing the size of the information to be transmitted. Since the header is equally large independently of the size of the image, the gain is larger at small images.

All steps of the compression procedure are working simultaneously, each with a part of the image data. A specific construction using FIFO:s (First In First Out) between the different steps of the compression procedure makes it possible to buffer data, if one or several steps are executed slower than an earlier one. When a FIFO is filled, the pipeline step before the filled FIFO is temporary stopped, until it starts to be emptied. Hence, the compression procedure is optimally performed, and due to parallel working pipeline steps and because of the fact that a FPGA or an ASIC is used, the clock frequency can be decreased in comparison with a general construction having a CPU having sequential steps, thereby saving power. Normally, only the part of an image, which has changed in comparison with a previous image, is transmitted, i.e. the blocks that have changed since any previous image.

Furthermore, the compression is adapted to the number of required hops within the network to reach a desired destination. At normal signal quality of the radio transmission, the images/videos are compressed in the normal way and the radio having the broad bandwidth is used for the transmission. When the signal quality is lower than the normal one, the images are further compressed for reducing the image data to be transmitted, still over the radio having a broad bandwidth. However, the transmission will be performed via the multi-hop radio when the signal quality of the radio having the broad bandwidth is too low, i.e. when transmission is almost impossible. In this situation the compression of image data is made harder to decrease the amount of data to be sent, thereby saving power. The amount of power needed for the nodes involved increases with the number of hops.

The radio baseband controller 34 performs the configuration of and communicates with the external radio baseband unit 27. The data from the compression pipeline is arranged into packets by the baseband controller 34 before sending them to the baseband unit 27.

The sub control unit 36 controls the flow of image data, i.e. where the image data should be sent; from the camera interface 30 to the memory 25 via the memory interface 32, from the memory 25 to the image analysis unit 31 or to the compression pipeline 33. The sub control unit 36 is also aware of the data addresses in the external memory 25. The broad arrows in FIG. 3 illustrate the data flow.

The main control unit 35 controls all other units 30, 31, 32, 33, 34, 36 of the processor 24 by instructions from the external CPU 21, which gets a report from the main control unit 35 when the work is completed and which thereafter shuts off the processor 24 to save power.

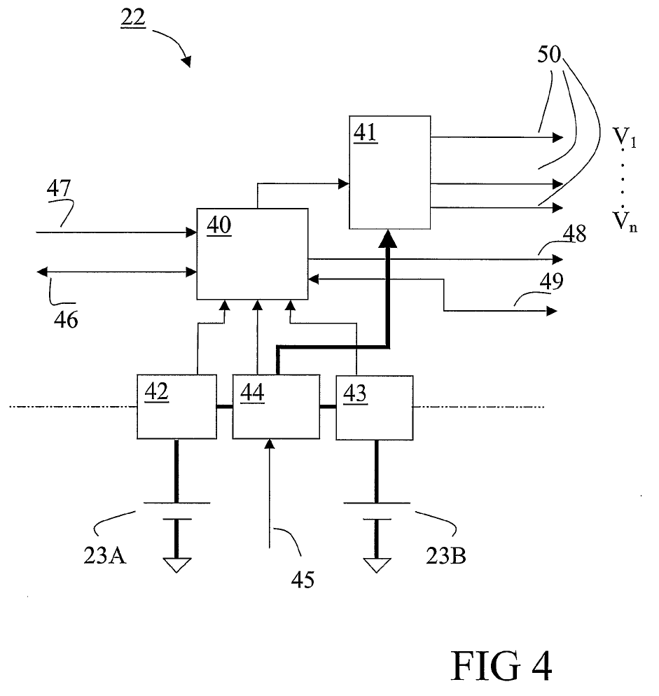

With reference to FIG. 4, the power management unit 22 comprises a CPU 40 including software and logic, a power multiplexer 41, fuel gauges 42 and 43, a charger-and-power selector 44, a connection for external power supply 45, a digital interface 46 to the CPU 21, an input 47 for a trigger signal from an external sensor 3, an output 48 for a battery status signal and a connection 49 for a wake up signal. The CPU 40 and the CPU 21 incorporate the required intelligence for operating the power management unit 22. The fuel gauges 42 and 43 monitor the batteries 23A and 23B, respectively, when both batteries 23A and 23B are in use. However, since often only one battery 23A, 23B is in use, only one fuel gauge 42, 43 is activated to save power. At specific occasions and after a certain time period, such as before the camera 4 is put in sleep-mode, whereby the voltage is the lowest, the CPU 40 can check the battery status, e.g. if the battery level is below a set value; this information will be transmitted to the CPU 21 or to the processor 24 through the output 48. If the voltage of the camera 4 is too low at start up, the two batteries 23A and 23B will be coupled in parallel, since a higher current may be needed.

The charger-and-power selector 44 operates parallel with the fuel gauges 42, 43, where one of its main function is to electronically switch between the batteries 23A, 23B for continuous power supply to the camera 4, and when necessary charge the batteries. At charging, an external voltage supply, e.g. of 5-24 V, is connected to the connection 45. In critical situations, the charger-and-power selector 44 can decide how the battery capacity should be used on demand of the CPU 40, and if the first battery 23A indicates a too low level, the second battery 23B will automatically be switched into operation for supplying the sensor 3, the CPU 21 and the power management unit 22. The processor 24, the memory 25, the camera chip 26 and the radio module 27 of the camera 4 are also supplied by the battery 23B. When the components 24, 25, 26 and 27 cannot be activated by a single battery, this is registered by the camera 4, since the CPU 21 does not receive any answer from the processor 24 through the configuration interface 29 at start up, or since the power management unit 22 does not receive any confirmation from the processor 24 regarding correctly start up of the camera 4. To be able to power supply the camera components 24, 25, 26 and 27, the CPU 40 gets an order to arrange the batteries 23A, 23B in a parallel coupling, resulting in larger current capability than if a single battery 23A, 23B is used.

The function of the power multiplexer 41 is to properly distribute required voltages in due time to each component of the camera 4, via voltage outputs 50. The start up of the processor 24 is the most critical moment, since the processor 24 requires that different voltages are delivered correctly at different times to ensure a faultless start up. The multiplexer 41 is also responsible for supplying voltages solely to the components of the camera 4 which at a specific moment needs power, a fact that saves power.

The low power management solution for the wireless camera using dual radio techniques will be described in the following. The parts of the camera 4, which are resting during normal operation, are without power supply, to save power. However, there is an exception for the external sensor 3 and the CPU 21 which need a small, continuous power supply despite resting or being in a sleep-mode. The power management unit 22 supplies voltages to all parts of the camera 4, which can be used alone or integrated into a larger system using multi-hop radio technology, for example into a surveillance and alarm system.

The camera 4 can be waked up in four different ways; intermittently by the CPU 21, or by the external sensor 3, or by the radio transceiver 20, 27. Referring to the first mode, the integrated oscillator of the CPU 21 wakes up the CPU 21 at constant intervals, and performs predefined tasks.

In the second mode, an external sensor 3, e.g. a PIR-sensor, is activated by an incident, and the power management unit 22 then automatically starts up the processor 24, the radio module 27 and the camera chips 26. The CPU 21 will not tell the camera 4 what to do, instead the incident triggers the camera 4 to execute certain duties determined by pre-programmed default settings of the processor 24. Further, automatic settings of the camera 4 are used to achieve the highest possible quality at image exposure.

In the third mode the CPU 21 uses the radio transceiver 20 to get information about the activities to be performed by the camera 4 and to give instructions about activities to be performed. The whole performance is controlled by the multi-hop radio. The camera 4 is battery supplied in these first, second and third modes.

In the fourth mode, the camera system is externally waked up by a radio message from the radio transceiver 27, whereby external power supply is an advantage, since the camera 4 is activated and listens continuously.

When the camera 4 is waked up according to one of above mention ways, the processor 24 starts to operate according to obtained instructions. The power management unit 22 receives a signal and starts battery testing, which will be explained below, and then turns on the voltages of the camera 4 in proper order. The processor 24 is pre-programmed to listen to the configuration interface 29 at start up, and reads the specific settings for the camera 4 and instructions how to act. The processor 24 performs the requested work—exposures images, analyses the images and compresses the images—and sends thereafter the information by radio to a desired address, receives a confirmation about safe receipt and sends finally a message to the CPU 21 confirming fulfilled duties. The CPU 21 then tells the processor 24 to enter the sleeping mode, and signals to the power management unit 22 to turn off the feeding voltages to the different parts of the camera 4 in correct order. The power management unit 22 sends back a signal to the CPU 21 for informing about the battery status of the two batteries 23A and 23B, which information then is sent by the multi-hop network to a desired address of the radio network. The camera 4 is now ready to be initiated once again.

In the second mode above, the processor 24 is automatically turned off, when the duties are fulfilled. Some messages, as low battery level, is transmitted by the multi-hop radio network, e.g. to the control panel 2.

The camera 4 is power supplied by two batteries 23A, 23B. The battery 23A is intended for supply of power to the CPU 21 and the power management unit 22, an eventually the external sensor 3. In wake up mode, battery 23A supplies the CPU 21 and the radio transceiver 20. Battery 23B is not activated all the time, but will on demand supply the processor 24, the radio module 27, the camera chip 26 and the memory 25.

There is a risk for oxidization of the batteries 23A, 23B if no incident wakes up the camera 4 during a long time period, which can result in difficulties to deliver sufficient power for starting up the components of the camera 4. However, the camera 4 is aware of the length of the time period that has lapsed since the components of the camera 4 were activated and in operation. If this time period passes a value, set by the multi-hop network, the camera 4 can act in two ways for eliminating the risk of a failure. Firstly, the CPU 21 can order the power management unit 22 to chock the batteries 23A, 23B, which is done by taking out a great amount of power through a transistor during a short time. Secondly, the camera 4 can be started with the batteries 23A, 23B parallel coupled as described above, which offers a larger current capability and a safer operation when the batteries 23A, 23B have been used for a while.

For a better understanding, some examples of how the compression could be adapted in relation to the number of hops in a multi-hop network are given below.

To determine a critical BERmax (Bit ERror) level at which an action should be done to decrease the data size, the transmission rates of the fast radio link A is divided with the transmission rate of the multi-hop link B, and this value is divided with the ratio of current consumption required for each link. If for example, the link A has a rate of 500 kbit/s and the link B has a rate of 100 kbit/s, and the link A consumes 3 times more current than the link B, this results in (500/100)/3=5/3.

This value should correspond to (1+BERmax), i.e. BERmax is (5/3)−1=2/3 in this example, which means that at about a BERmax of 67%, measures must be performed to decrease the size of the images. The levels between 0 and BERmax is divided in four portions, and at each higher level, the quantization is made one step harder, or the image resolution is divided in width and height, according to the following table.

| | Number | Quantization/Resolution |
|---|---|---|
| BER level | of hops | adjustment |
| 3/4 BERmax | 1-3 | quantization * 2 |
| | 4- | quantization * 4 |
| 1/2 BERmax | 1-3 | quantization * 4 |
| | 4- | quantization * 8 |
| 3/4 BERmax | 1-3 | quantization * 8 |
| | 4- | resolution halving, normal |
| | | quantization |
| BERmax | 1-3 | resolution halving, normal |
| | | quantization |
| | 4- | resolution halving + |
| | | quantization * 2 |
| 5/4 BERmax | 1-3 | resolution halving + |
| | | quantization * 2 |
| | 4- | resolution halving + |
| | | quantization * 4 |
| 6/4 BERmax | 1-3 | resolution halving + |
| | | quantization * 4 |
| | 4- | resolution halving + |
| | | quantization * 8 |
| 7/4 BERmax | 1-3 | resolution halving + |
| | | quantization * 8 |
| | 4- | resolution halving, twice, |
| | | normal quantization |
| 2 BERmax | 1-3 | resolution halving, twice, |
| | | normal quantization |
| | 4- | resolution halving, twice + |
| | | quantization * 2 |
| Etc. | | |

This describes case 2 of the compression method.
In case 3 of the method, when there is no contact via the link A, the quantization level and the resolution division are described as follows:
1 hop => normal quantization
2 hop => quantization * 2
3 hop => quantization * 4
4 hop => resolution halving, normal quantization
5 hop => resolution halving + quantization * 2
6 hop => resolution halving + quantization * 4
7 hop => resolution halving + quantization * 8
8 hop => resolution halving * 2 + normal quantization
Etc.

In this case, the normal resolution of the image is always lower than in case 1 and 2, for example 320*240 pixels or 160*120 pixels.

A method for performing image exposure, image processing and image compression will now be described step by step with reference to FIG. 3, wherein the data flow is illustrated by broad arrows.

In a step one, the functional parameters are set by an operator, e.g. the number of images requested, the resolution of the images, exposure at specific time intervals and if zooming should be used and if the images should be in colour or black-and-white, registration of changes of the image, etc. A command including those parameters is sent from the external CPU 21 via the CPU interface to the main control unit 35.

In a step two, the main control unit 35 asks the sub control unit 36 to start the exposure of required images from the camera interface 30 and to store those into the external memory 25.

In a step three, the sub control unit 36 starts to accept data from the camera interface 30, which has converted the data—if necessary—to a format suitable for further image processing and compression. Received data is sent to the memory controller 32, which sends writing commands to the external memory 25 for each data burst. The sub control unit 36 informs the main control unit 35 by a signal, when it has fulfilled its duties.

In a step four, the main control unit 35 asks the sub control unit 36 to reread one or two images for processing into the image analysis unit 31, wherein the desired image processing functions are set by the main control unit 35. At ordinary compression, without further image processing, a DCT-conversion should be done.

In a step five, a block of pixels (8*8 pixels) of each image is reread from the memory 25 every time and is sent to the image analysis unit 31, wherein the requested function is executed and a processed block of pixels is sent back to the sub control unit 36 for writing to the external memory 25. Alternatively, if the image data is not changed by the image analysis, certain information is selected about the image, which is read by the main control unit 35, and then no data has to be written to the memory 25.

In a step six, the main control unit 35 orders the sub control unit 36 to start reading images from the memory 25 for further transmission to the compression pipeline 33.

In a step seven, the sub control unit 36 starts to read image data, block by block (8*8 pixels), from the memory 25 by the memory controller 32. The memory controller sends reading commands to the memory 25 and receives data from the memory 25, which is sent to the sub control unit 36.

In a step eight, the image data blocks are sent to the image analysis unit 31 for DCT-conversion, if this has not been performed in step 5 above, otherwise the blocks are sent directly to the compression pipeline 33. The image data is compressed step by step.

In a step nine, the compressed data exits the compression pipeline 33 as a bit stream packed in bytes. The bit stream is sent to the radio baseband controller 34, which sends it over the radio baseband 27 to a receiving unit, if there is a connection, otherwise the data flow will be sent to the multi-hop radio module 20 via the CPU 21 (shown by the arrows with broken lines in FIG. 3). When the compression pipeline 33 feeds data faster than the radio baseband controller 34 manages to send data, or if there is no connection, the compression pipeline interrupts its activities until a signal from the radio baseband tells that further data can be received.

In a step ten, the sub control unit 36, which is well aware of the number of requested images, informs the main, control unit 35 when all requested images have been compressed.

In a step eleven, the main control unit 35 informs the external CPU 21 that requested duties has been performed.

In a step twelve, the CPU 21 shuts off the power supply to the processor 24, and the performance of the method terminates.

A method for transmission of images within the wireless surveillance and alarm system 100 will now be described below. Videos or images which are exposed and processed by the camera 4 are stored in the camera 4 or are sent to the connection unit 1 and further to an external destination via for example a broadband connection 5, GSM/GPRS 6, telephone network 7 or PAL/NTSC 8, as illustrated by an arrow C.

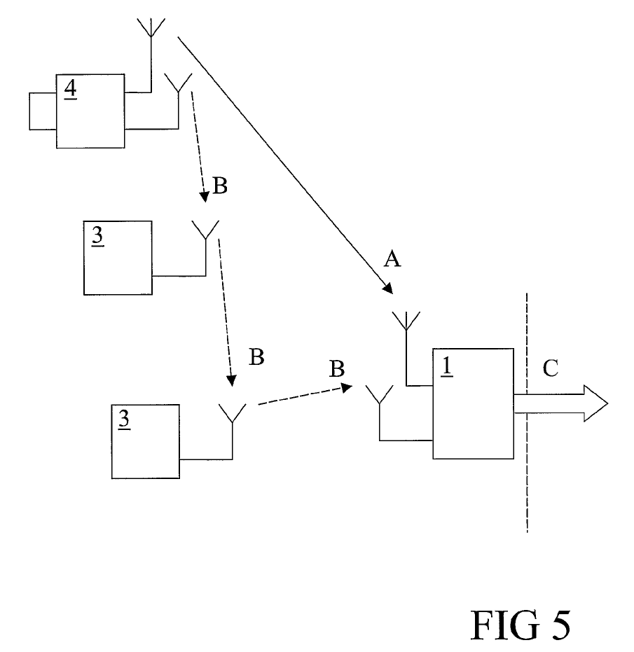

As illustrated in FIG. 5, the transmission within the network should in first hand use a dedicated radio link having a relatively large bandwidth, arrow A, from the radio module 27, and in second hand use the multi-hop radio link having a relatively low bandwidth, arrow B, over the radio module 20. When using the radio module 27, which has a broader bandwidth than the radio module 20, the transmission of images will be faster. Further, the radio module 27 has more frequencies to change between for the transmission in comparison with the radio module 20, which makes it more difficult to interfere with the transmission. The camera 4 is battery-operated, therefore the radio link A is closed when there are no images to send and the multi-hop radio 20, which is active during time intervals, is sending during as short time periods as possible to save power. When the connection unit 1 has received an image from the camera 4, the image should be sent further from the surveillance and alarm system, often on a bandwidth broader than the radio link B. The image compression should be done with JPEG, as previous mentioned, to keep a high quality of the images. The camera 4 is able to exposure images having different resolutions, from for example 2048*1536 pixels to 160*128 pixels. An object to achieve for the system 100 is to send as many images as possible per second, or to get the impression thereof, using one of the radio links A or B, and to send with as low power consumption as possible. In the first place the camera 4 should send images over the radio link having the broadest bandwidth A, and when finished close down the radio module 27. In the second place the multi-hop radio link B should be used. The camera 4 is able to control the best way for sending, i.e. the way that consumes the smallest amount of power in relation to the quality of the images. When the signal quality is good from a receiving unit over the radio module 27 this one is used, and high quality compressed pictures are sent. However, if the signal quality is bad, i.e. below a preset value, the camera 4 increases the transmission strength up to maximum output power. If the BER is above a value, as indicated in the table above, the camera 4 will lower the resolution of the images and further compress the images with increased quantization, resulting in a smaller data size of the images to send. The quantization level can be increased in several steps depending on the number of hops over the multi-hop radio 20 to the connection unit 1. The images could be sent in black-and-white in order to further reduce the data rate. The compression degree should correspond to the power consumption needed to send the images over the multi-hop radio 20, which is sensed by the camera 4, and yet the transmission will be performed over the radio link A or the multi-hop radio 20. If it is impossible to get contact over the radio link A, the camera 4 uses the multi-hop radio 20 for sending images. The camera 4 knows the number of hops needed to reach the connection unit 1 and this number determines the quantization of the images, in addition, a lower image resolution is chosen to speed up the transmission. The connection unit 1 can later order the original image having a high resolution that is stored in the memory 25. At transmission within the multi-hop network a reserved route is used from the camera 4 to the connection unit 1 for messages and images.

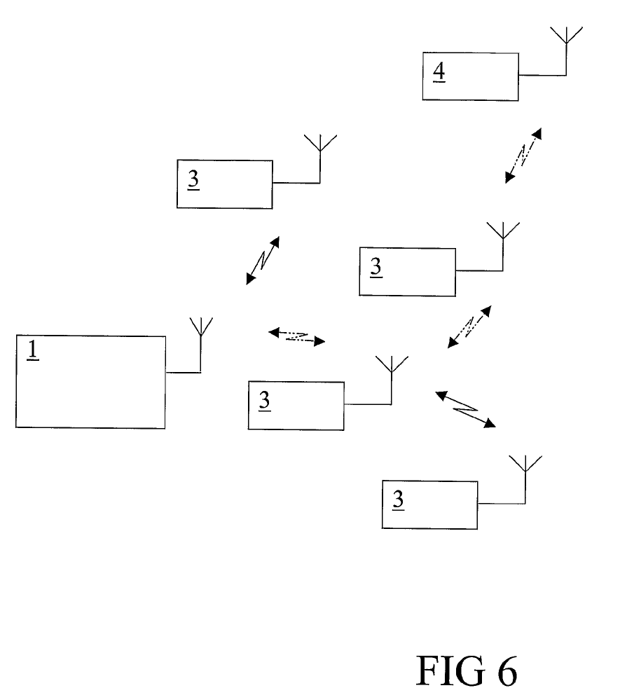

When the camera sensor is activated, the camera 4 is started and exposures the preset number of images, simultaneously an alarm message is sent to the connection unit 1. If the camera sensor senses that the radio module 27 cannot be used for sending the images, the multi-hop radio 20 must be used. The camera sensor then sends a message over the multi-hop network to the connection 1 for informing that there are images to be sent over the network. One of the sensors 3, which is a node of the network and which receives the message, registers that the camera has images to be sent and sends thereafter the message further to the next node, the procedure being repeated until the message reaches the connection unit 1. The connection unit 1 registers the message and sends back a confirmation to the camera sensor via the same way as used for the message. The intervening nodes prepares for the transmission. When the camera sensor receives the confirmation it knows that there is a reserved route for sending the images, as illustrated by the arrows with broken lines in FIG. 6. If it fails to reserve a route for the images, the camera 4 will make a new effort after a while, until a route has been found. The method for transmission images described above is performed to get optimal quality of images to be reliable sent in relation to lowest possible power consumption.

There are many advantages of the wireless system for surveillance and alarm 100 according to the invention compared to currently used alarm systems. For example currently used alarm systems having cameras are in most cases power supplied by wires, since the amount of power normally is insufficient from a battery for a continuous, reliable performance of these cameras.

The system for surveillance 100 according to the invention provides a safer radio technology and will cover a larger area than the technology of the prior art.

The connection unit 1 will periodically wake-up the entire system 100 for checking that all sensors 2, 3, 4 still are present and that no one has disappeared or is not working. Simultaneously, the sensors 2, 3, 4 are able to regularly send information, e.g. regarding battery status; to the connection unit 1 when the system 100 wakes up, which ensures a proper operation thereof.

The central unit of currently used security systems is easy to bring out of use by sabotage. The system according to the invention has instead of a central unit a connection unit 1 and a control unit 2, which can be kept apart, the connection unit 1 can advantageously be hidden away to prevent sabotage and the control unit 2 can be suitably placed for daily use. The system can continue to work despite a broken control unit 2.

The multi-hop radio technology provides a dynamic alarm network. It is easy to add sensors 3, 4 to the system 100 and to dynamically move between different zones.

Although the present invention has been described above with reference to specific embodiments, it is not intended to be limited to the specific form set forth herein. Rather, the invention is limited only by the accompanying claims and other embodiments than those specifically described above are equally possible within the scope of these appended claims.

In the claims, the term “comprises/comprising” does not exclude the presence of other elements or steps. Furthermore, although individually listed, a plurality of means, elements or method steps may be implemented. Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way. The scope is only limited by the patent claims.

1. A method for transmission of a large amount of information, such as images, videos and sound, over a radio frequency link, the method comprising performing the transmission: i) on a first frequency at normal signal quality of the transmission and at full rate of the information; ii) on the first frequency but with the information being further compressed when the signal quality of the transmission is below the normal signal quality; and iii) on a second frequency when the transmission on the first frequency is substantially impossible.

2. The method according to claim 1, wherein the compression of the information is performed in several steps, depending on the signal quality and the number of hops during transmission during the steps ii) and iii).

3. The method according to claim 1 wherein transmission at the second frequency takes place over several nodes in a multi-hop network in a predetermined path.

4. The method according to claim 2 wherein the transmission takes place in both directions.

5. The method according to claim 1, wherein the information comprises image information, characterized by compressing the image information according to JPEG-standard including a header, and removing the header before transmission.

6. The method according to claim 1, further comprising removing the header during the steps ii) and iii).

7. The method according to claim 1, wherein the image information is obtained by a camera unit and sent to a connection unit, comprising steps of:—receiving configuration information from the connection unit for a processor of the camera unit,—applying power to the processor,—performing a configuration task,—sending information to the connection unit via a CPU when the task is completed, and—powering down the processor.

8. The method according to claim 7, comprising steps of:—providing power by a first battery to the CPU (21), an external sensor, and a power management unit,—providing power by a second battery to the processor, a memory and camera chips, and—connecting the two batteries in parallel at low voltage or when higher current is required.

9. A system comprising a radio module transmitting at a first frequency and having a first bandwidth, wherein the system comprises an additional radio module transmitting at a second frequency having a second bandwidth, which is smaller than the first bandwidth.

10. The system according to claim 9, wherein the additional radio module is a multi-hop radio module.

11. The system according to claim 9 wherein the system comprises at least one camera having at least one camera chip.
